(19) United States
(12) Patent Application Publication
(10) Pub. No.: US 2012/0288129 A1
(43) Pub. Date: Nov. 15, 2012

(54) Open-back woofer baffle with resonance control ports

(76) Inventor: Jame Ronald Suhre, N. Las Vegas, NV (US)

(21) Appl. No.: 13/068,402

(22) Filed: May 11, 2011

(51) Int. Cl. H04R 1/02

(52) U.S. Cl. 381/345

(57) ABSTRACT

A preferred embodiment of an open-back extended frequency range woofer baffle having ports to control longitudinal acoustic resonances.

### BACKGROUND

### Prior Art

The following is a tabulation of some prior art that presently appears relevant:

U.S. Patents

| Pat. No. | Kind Code | Issue Date | Patentee |
|---|---|---|---|
| 3,136,387 | B1 | 1964 Jun. 09, | Hopkins |
| 6,411,720 | B1 | 2002 Jun. 25, | Pritchard |
| 6,665,412 | B1 | 2003 Dec. 16, | Mizognchi |
| 3,578,103 | B1 | 1971 May 11, | Lennes |
| 4,122,302 | B1 | 1978 Oct. 24, | Bobb |

The IES Standard test baffle (dipole) would be nearly ideal for domestic use in that it does not adversely affect (color) speaker output as conventional box speakers do because of a) internal acoustic resonances, b) acoustic energy retention which degrades transient performance, and c) box edge diffraction (with a dipole, the front and back waves are of opposite phase when they meet at the baffle edge and cancel at that point). Also, the baffle size (53 in. by 65 in.) provides a good approximation of the desired low frequency (LF) roll-off if the woofer fundamental resonance is no higher than the low 20's Hz.

Furthermore, a dipole speaker provides a decisive characteristic for domestic use in that it minimizes the excitation of room acoustic resonances. The characteristic dipole FIG. 8 radiation pattern has a null in the plane of the speaker which does not excite lateral resonances, (and reduce wall and ceiling reflections) and since the front and back surfaces of the moving speaker element produce nearly equal but opposite excitation of the fore and aft room resonances, these are also not excited.

However, the baffle dimensions are too large for practical domestic use.

The purpose of this invention is to modify the shape of the Standard baffle to make it practical for domestic use with negligible loss of it's excellent acoustic characteristics.

First, by making it a floor standing design, the 65 in. dimension can be as small as half that because the floor blocks cancellation on that side of the woofer. Then, the sides adjacent to the woofer can be folded back, obtaining a practical footprint of approximately 13 in. by 20in.. The baffle still performs as a dipole because the acoustic wavelength is much longer than the baffle sides at the highest frequency used.

Unfortunately, the side panels creates an acoustic resonance behind the woofer of approximately 170 Hz, which would interfere with designing a suitable crossover to the mid range speaker. Since acoustic absorption materials are not effective at these low frequencies, some other approach is required. The solution is to use ports in the sides of the baffle just large enough to dissipate the energy build-up in the resonance, and to shift resonance frequencies up the same way finger holes function in wind musical instruments. This is very effective, and is a key part of this invention.

### SUMMARY

A near ideal woofer baffle is obtained by adding resonance control ports to an open-back version of the IES Standard open panel baffle.

### Advantages

The use of acoustic resonance control ports facilitates the design of a practical sized dipole woofer with near ideal bass reproduction characteristics for domestic use.

### DRAWINGS

### Figures

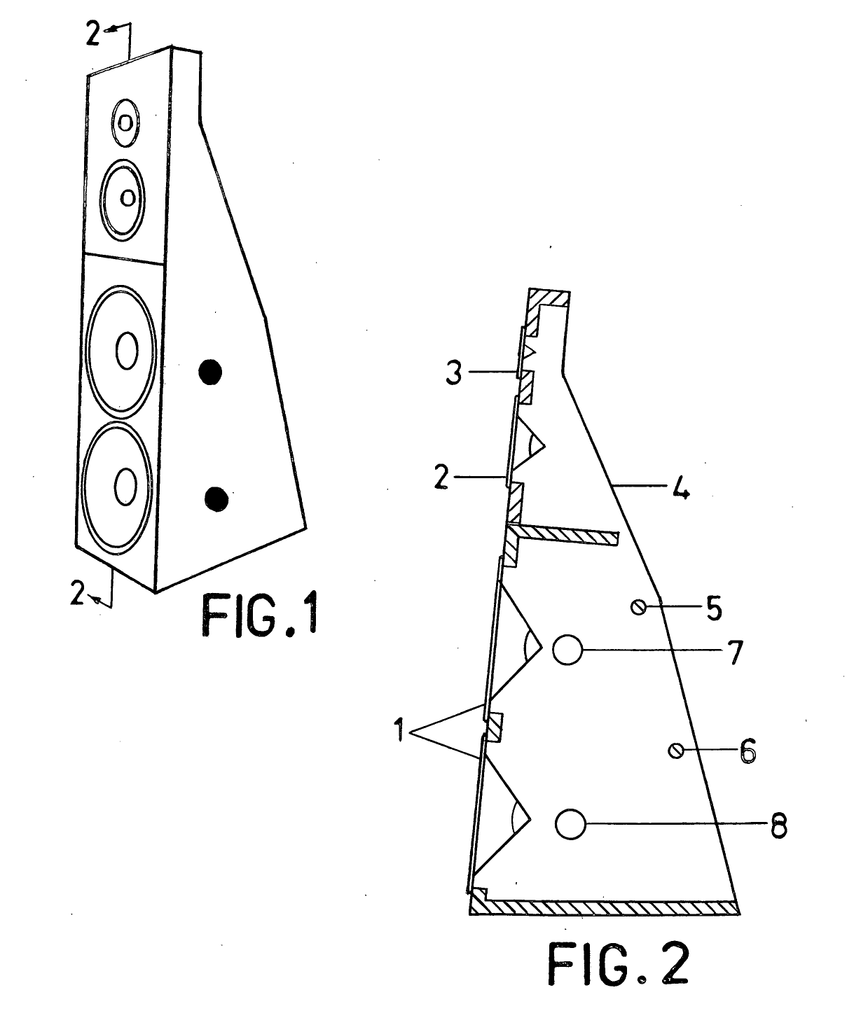

FIG. 1 isometric view of preferred embodiment.

FIG. 2 vertical centerline cross-section of FIG. 1.

### REFERENCE NUMERALS

1 low frequency electrodynamic acoustic transducer “woofer”

2 low to mid frequency electrodynamic acoustic transducer “mid-woofer”

3 open back high frequency electrodynamic acoustic transducer “tweeter”

4 baffle

5 lateral brace

6 lateral brace

7 acoustic resonance control port

8 acoustic resonance control port

### DETAILED DESCRIPTION

### FIGS. 1 and 2—Preferred Embodiment

The preferred embodiment of the woofer system for domestic use is illustrated in FIG. 1 (isometric) and FIG. 2 (vertical cross-section on centerline).

The low frequency portion of this full range speaker system consists of one or more woofers 1,2 mounted on the front panel of a five sided heavy walled box open to the rear 4. Optional lateral braces 5,6 are included to reduce side panel deflection. Located in the side panels approximately one third back from each woofer is a port (two per woofer) having a combined area just large enough to drain off the acoustic resonance energy build-up.

### Advantages

By incorporating one or more ports as described above the many advantages of dipole woofer acoustics is obtained in a practical sized baffle with proper LF roll-off, and excellent uncolored bass reproduction. When combined with dipole mid and dipole tweeter transient response is virtually flawless.

I claim:

1. An acoustic duct open at one end with an electrodynamic acoustic transducer at the other end, and with one or more ports in the side wall to control internal longitudinal acoustic resonances.

2. An open-back speaker enclosure with one or more ports in the side wall to control internal longitudinal acoustic resonances.

3. A floor standing open-back speaker baffle with a woofer near the floor on the front panel, and side walls shaped to approximate a horn to enhance acoustic coupling with the room, and with one or more ports in the side walls to control longitudinal acoustic resonances.
